(19) United States
(12) Patent Application Publication
(10) Pub. No.: US 2024/0310874 A1
(43) Pub. Date: Sep. 19, 2024

(54) INFLATABLE PAD AND ADJUSTMENT MECHANISM FOR AUGMENTED OR VIRTUAL REALITY HEADSETS

(71) Applicant: Meta Platforms Technologies, LLC, Menlo Park, CA (US)

(72) Inventors: Meng Peng, Sammamish, WA (US); Christopher Sa Glaister, Oakland, CA (US)

(21) Appl. No.: 18/391,061

(22) Filed: Dec. 20, 2023

Related U.S. Application Data
(60) Provisional application No. 63/490,009, filed on Mar. 14, 2023.

(51) Int. Cl. G06F 1/16; G02B 27/01

(52) U.S. Cl. CPC G06F 1/163; G02B 27/0176

(57) ABSTRACT

A headset includes a head-mounted display, a band connected to the head-mounted display, an inflatable pad positioned on at least one of the head-mounted display or the band, the inflatable pad including at least one chamber, and a pump mechanism configured to inflate the at least one chamber. The inflatable pad may be configured to adjust the fit of the headset for a wearer.

### CROSS REFERENCE TO RELATED APPLICATION

This application claims the benefit of priority under 35 U.S.C. § 119(e) of U.S. Provisional Application No. 63/490,009, filed Mar. 14, 2023, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an illustration of an exemplary inflatable pad and adjustment mechanism for augmented or virtual reality headsets.

FIG. 2 is an illustration of exemplary augmented-reality glasses that may be used in connection with embodiments of this disclosure.

FIG. 3 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Virtual reality (VR) and augmented reality (AR) eyewear devices and headsets may enable users to experience events, such as interactions with people in a computer-generated simulation of a three-dimensional world or viewing data superimposed on a real-world view. By way of example, superimposing information onto a field of view may be achieved through an optical head-mounted display (OHMD) or by using embedded wireless glasses with a transparent heads-up display (HUD) or augmented reality (AR) overlay. VR/AR eyewear devices and headsets may be used for a variety of purposes. Governments may use such devices for military training, medical professionals may use such devices to simulate surgery, and engineers may use such devices as design visualization aids.

Wearable devices and systems may be configured to fit about a user's head or face. Variations of human facial geometries and unevenly distributed facial pressure, however, may contribute to discomfort and a poor interactive experience. In some embodiments, a headset or other wearable device may include a gas-filled contact pad (e.g., bladder) that is configured to evenly distribute pressure to the facial region of a user. A pump may be used to adjust and/or maintain a desired pressure level within the contact pad. Accordingly, the pump may be configured to adjust the fit of the headset particularly in response to changes in the local environment, i.e., changes in atmospheric pressure.

The present disclosure is generally directed to an inflatable pad and adjustment mechanism that can be used to achieve a desired fit for an augmented reality and/or virtual reality headset. This inflatable pad may, when used alone or in combination with other adjustment mechanisms, allow a wearer to properly secure and finely tune the fit and comfort of their headset.

Features from any of the embodiments described herein may be used in combination with one another in accordance with the general principles described herein. These and other embodiments, features, and advantages will be more fully understood upon reading the following detailed description in conjunction with the accompanying drawings and claims.

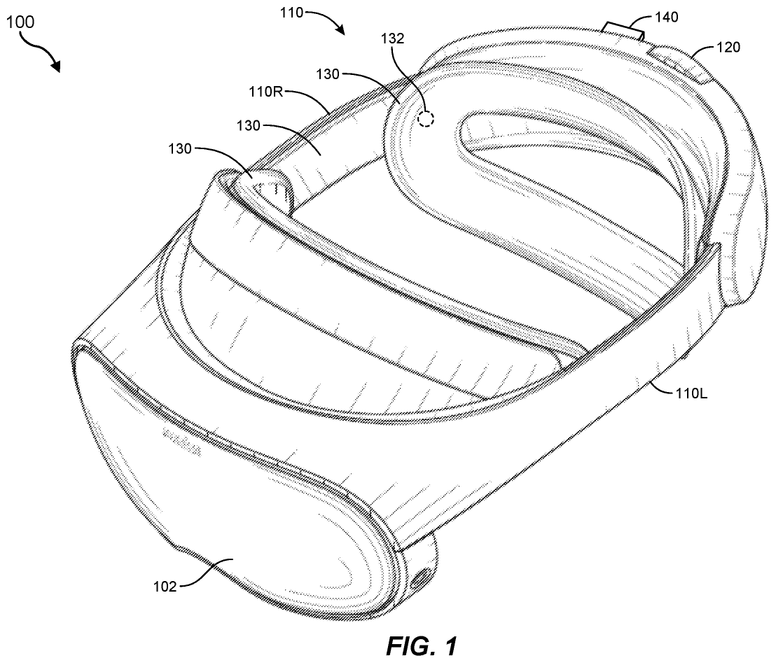

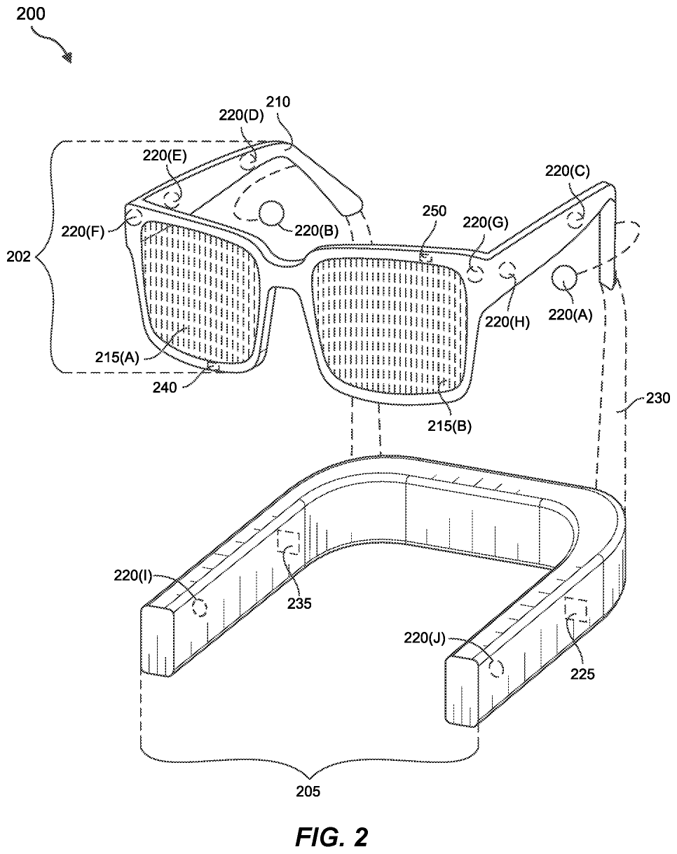

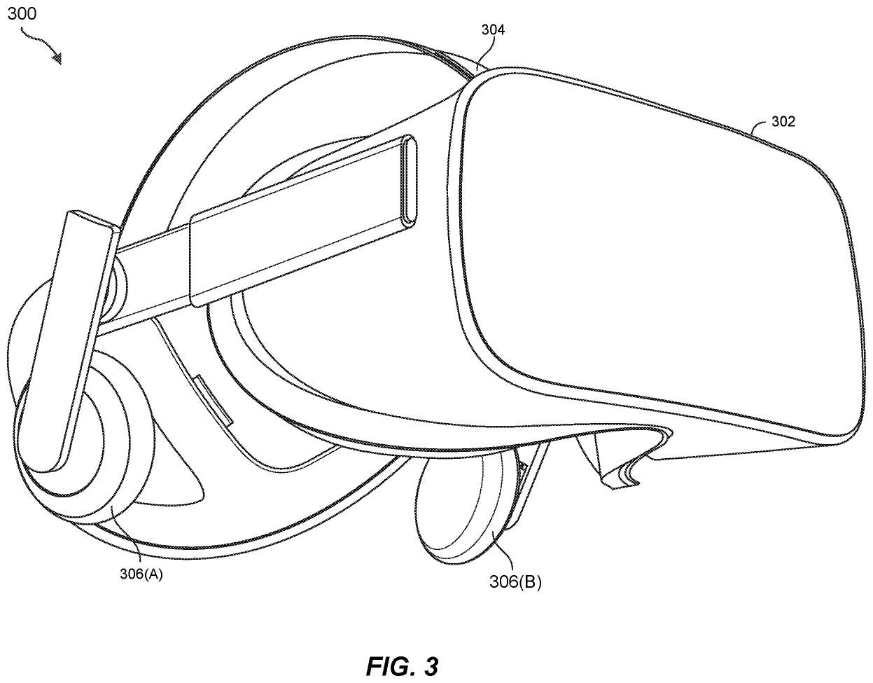

The following will provide, with reference to FIGS. 1-3, detailed descriptions of structures and methods associated with an adjustable headset. The discussion associated with FIG. 1 includes a description of a headset having an inflatable pad and associated methods of use. The discussion associated with FIGS. 2 and 3 relates to exemplary virtual reality and augmented reality devices that may include such a headset.

As shown in FIG. 1, an augmented reality or virtual reality headset 100 may include an adjustable band 110 and an HMD (head-mounted display) 102. A wearer may wear the headset 100, such that the adjustable band 110 at least partially surrounds the head of the wearer and the HMD 102 is visible by one or both eyes of the wearer.

The adjustable band 110 generally represents any type or form of mechanism for securing an HMD to the head of a wearer. In some embodiments, the adjustable band 110 may be configured to attach to and/or detach from the HMD 102. In other embodiments, the adjustable band 110 may be permanently attached to the HMD 102. As shown in FIG. 1, the adjustable band 110 may include a left side arm 110L and a right side arm 110R.

The adjustable band 110 may include a rigid material. Additionally, or alternatively, the adjustable band 110 may include a compliant (i.e., stretchable) material. In some embodiments, the adjustable band 110 may include a spring-biasing mechanism that helps secure the headset 100 to a wearer's head. The adjustable band 110 may also include a tensioning device 120. In some embodiments, the tensioning device may include an adjustment knob. In these embodiments, the wearer may adjust a tension of the adjustable band 110 (and thus a fit of the headset 100) by adjusting a position (e.g., rotating, sliding, etc.) of the tensioning device 120.

In some embodiments, the headset 100 may include at least one inflatable pad 130. The inflatable pad 130 generally represents any type or form of inflatable or expandable pad or bladder. The inflatable pad 130 may include a flexible and durable material. Example materials may include polymer-based compositions, e.g., a vinyl-based material. The inflatable pad 130 may be disposed on and/or incorporated within a variety of components of the headset 100, such as, for example, a portion of the left side arm 110L and/or a portion of the right side arm 110R (i.e., an interior surface of the adjustable band), a facial interface of the HMD 102 (i.e., an interior surface of the HMD 102 that would otherwise contact the face or forehead of a wearer when wearing the headset 100), and/or a rear strap of the adjustable band 110 (i.e., an interior surface of a strap that interfaces with a rear portion of a wearer's head when wearing the headset 100).

In some embodiments, the inflatable pad 130 may be positioned on one side of the adjustable band 110, such as either of the left side arm 110L or the right side arm 110R. In other embodiments, the inflatable pad 130 may be positioned on both sides of the adjustable band 110—both on the left side arm 110L and the right side arm 110R. In some embodiments, the inflatable pad 130 may be positioned on both the left side arm 110L and the right side arm 110R and a back portion of the adjustable band that connects the side arms.

In some embodiments, the inflatable pad 130 may include at least one chamber, configured to be filled with a fluid or gas, such as air. When the at least one chamber of the inflatable pad 130 is inflated, the adjustable band 110, the HMD 102, and/or other components of the headset 100 may achieve a more comfortable and/or more secure fit for the wearer. In some embodiments, the inflatable pad 130 may include more than one chamber. In the example of an inflatable pad having multiple chambers, the pressured state of each chamber may be independently controlled. Although the disclosure refers to filling the chamber with air, it is to be understood that other fluids or gases, including but not limited to water, carbon dioxide, or nitrogen, may be used to fill the inflatable pad 130.

Inflatable pad 130 may include at least one fluid port 132 positioned and configured to inflate and/or deflate inflatable pad 130. For example, fluid port 132 may be configured to inflate inflatable pad 130 upon receipt of a pressurized fluid from a pressurized fluid source. The pressurized fluid source may include, without limitation, a fan, a piston, a valve, a pump, a pressurized chamber, a compressor, or another fluidic device.

Inflatable pad 130 may include at least one fluid port 132 connected to a valve that controls a flow of pressurized fluid from the pressurized fluid source to inflatable pad 130. A valve may be a two-way valve, for example. Further, inflatable pad 130 may be coupled to a pressure sensor that measures the pressure level of the pressurized fluid. A controller may be configured to control a programmable pressure within inflatable pad 130 by controlling the flow of pressurized fluid to fluid port 132 and measuring the pressure level of the pressurized fluid.

In some embodiments, actuation of a pump mechanism 140 may fill the chamber of the inflatable pad 130 with air and/or may release air from the chamber. For example, in some embodiments, adjusting a position (e.g., rotating, sliding, etc.) of a component of the pump mechanism 140 in one direction may fill the chamber with air, and/or adjusting a position (e.g., rotating, sliding, etc.) of the same and/or another component of the pump mechanism 140 in another direction, such as an opposite direction, may release air from the chamber. In some embodiments, actuation of the pump mechanism 140 may actuate a manual pump, such as, for example, a bellows or a piston. In some embodiments, actuation of the pump mechanism 140 may actuate an electric pump, such as, for example, an electric air compressor. In some embodiments, the electric pump may receive power from a wired power source (such as an AC or DC power source). In some embodiments, the electric pump may be powered by a battery, such as a replaceable and/or rechargeable battery.

In some embodiments, the pump mechanism 140 may be operated by operation of the tensioning device 120. For example, in some embodiments, the tensioning device 120 may adjust the tension of the adjustable band 110 as well as fill the chamber of the inflatable pad 130 with air and/or release air from the chamber. In some embodiments, the pump mechanism 140 may be separate from the tensioning device 120. For example, in some embodiments, operation of the tensioning device 120 may not operate the pump mechanism 140.

In some embodiments, actuation of one component of the pump mechanism 140 may fill the chamber of the inflatable pad 130 with air, while actuation of another component of the pump mechanism 140 may release air from the chamber. In some embodiments, the component used to release air from the chamber may be a button, slide, or another mechanism. In some embodiments, the headset 100 may omit the tensioning device 120.

In some embodiments, the tensioning device 120 may be used to make relatively course adjustments to the fit of the headset 100 on the head and/or face of the wearer, while the pump mechanism 140 may be used to make relatively fine adjustments to the fit of the headset 100 on the face and/or head of the wearer. Thus, the pump mechanism 140 may allow the wearer or another person to adjust an amount of air within the chamber of the inflatable pad 130 to finely tune the fit and comfort of the headset 100. Accordingly, the wearer may achieve a desired fit of the headset 100 by adding more air to the inflatable pad(s) 130 and/or releasing air from the inflatable pad(s) 130. In some configurations, each of the fluid pressure within the inflatable pad and the adjustable band tension can be modified independently or jointly.

In some embodiments, the wearer may adjust the fit of the headset 100 based on the activity performed or to be performed while wearing the headset 100. For example, the wearer may desire a different fit of the headset 100 when the wearer is watching a video, and when the wearer is sitting relatively still, as compared to when the wearer is playing an interactive game, and is standing and moving. It may be, for example, that the wearer desires a tighter fit for the headset 100 when the wearer is standing and/or moving. Further, in some embodiments, the wearer may adjust the fit of the headset 100 due to environmental conditions. For example, when the wearer is traveling from a lower altitude to a higher altitude or vice versa (such as in automobile, train, or airplane), or when changes in atmospheric conditions change the relative pressure, the wearer may wish to tighten or loosen the fit of the headset 100, so that wearing the headset 100 remains comfortable.

In some embodiments, the inflatable pad 130, and associated components, may automatically adjust a pressure within the inflatable pad 130 based on content that is running, e.g., playing a video, or active game. In some embodiments, the inflatable pad 130, and associated components, may automatically adjust a pressure within the inflatable pad 130 based on a detected speed and/or acceleration of the wearer's actions. In some embodiments, the inflatable pad 130, and associated components, may automatically adjust a pressure within the inflatable pad 130 based on a detected ambient atmospheric pressure change.

Although the disclosure describe the inflatable pad 130 as applied to the headset 100, it is to be understood that the inflatable pad 130 is not limited to use on the headset 100, or even to a head-mounted device. Instead, the inflatable pad 130 may be applied to any device worn on the head (or another part of the body). By way of a few non-limiting examples, the inflatable pad 130 may be incorporated into a head-mounted device such as a flashlight, camera, or helmet, among other devices.

### EXAMPLE EMBODIMENTS

Example 1: A headset includes a head-mounted display, a band connected to the head-mounted display, an inflatable pad positioned on at least one of the head-mounted display or the band, the inflatable pad comprising at least one chamber, and a pump mechanism configured to inflate the at least one chamber.

Example 2: The headset of Example 1, where the inflatable pad includes vinyl.

Example 3: The headset of any of Examples 1 and 2, where inflatable pad includes two or more chambers.

Example 4: The headset of any of Examples 1-3, where the inflatable pad includes two or more independently inflatable chambers.

Example 5: The headset of any of Examples 1-4, where the pump mechanism includes a manual pump.

Example 6: The headset of any of Examples 1-4, where the pump mechanism includes an electric pump.

Example 7: The headset of any of Examples 1-6, further including a pressure sensor configured to measure a fluid pressure within the at least one chamber.

Example 8: The headset of any of Examples 1-7, further including a tensioning device configured to adjust a tension of the band.

Example 9: The headset of Example 8, where the tensioning device is configured such that operation of the tensioning device is independent of operation of the pump mechanism.

Example 10: The headset of any of Examples 8 and 9, where the inflatable pad is configured to be inflated or deflated independently from operation of the tensioning device.

Example 11: The headset of any of Examples 8-10, where the tensioning device is configured such that operation of the tensioning device operates the pump mechanism.

Example 12: The headset of any of Examples 8-11, where the tensioning device is configured to make coarse fitting adjustments, and the pump mechanism is configured to make fine fitting adjustments.

Example 13: The headset of any of Examples 8-12, where the tensioning device is configured to adjust an amount of fluid in the inflatable pad based on at least one of an atmospheric condition, a use of the headset, and a level of activity of a wearer.

Example 14: A headset includes a component, a band connected to the component, the band configured to be worn around the head of a wearer, an inflatable pad positioned on at least one of the component or the band, the inflatable pad including at least one chamber, and a pump mechanism configured to inflate the at least one chamber.

Example 15: The headset of Example 14, where the component includes one of a flashlight, camera, and helmet.

Example 16: The headset of any of Examples 14 and 15, further including a tensioning device configured to adjust a tension of the band.

Example 17: The headset of Example 16, where the tensioning device is configured such that operation of the tensioning device is configured to adjust an amount of fluid in the inflatable pad.

Example 18: The headset of any of Examples 16 and 17, where the tensioning device is configured such that operation of the tensioning device operates the pump mechanism.

Example 19: A headset includes a head-mounted display, a band connected to the head-mounted display, the band configured to be worn around the head of a wearer, and an inflatable pad positioned on at least one of the head-mounted display or the band, the inflatable pad including at least one chamber, where the at least one chamber is configured to be inflated by a fluid.

Example 20: The headset of Example 19, further including a pressurized fluid source configured to inflate the at one chamber with the fluid.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (e.g., augmented-reality system 200 in FIG. 2) or that visually immerses a user in an artificial reality (e.g., virtual-reality system 300 in FIG. 3). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 2, augmented-reality system 200 may include an eyewear device 202 with a frame 210 configured to hold a left display device 215(A) and a right display device 215(B) in front of a user's eyes. Display devices 215(A) and 215(B) may act together or independently to present an image or series of images to a user. While augmented-reality system 200 includes two displays, embodiments of this disclosure may be implemented in augmented-reality systems with a single NED or more than two NEDs.

In some embodiments, augmented-reality system 200 may include one or more sensors, such as sensor 240. Sensor 240 may generate measurement signals in response to motion of augmented-reality system 200 and may be located on substantially any portion of frame 210. Sensor 240 may represent a position sensor, an inertial measurement unit (IMU), a depth camera assembly, a structured light emitter and/or detector, or any combination thereof. In some embodiments, augmented-reality system 200 may or may not include sensor 240 or may include more than one sensor. In embodiments in which sensor 240 includes an IMU, the IMU may generate calibration data based on measurement signals from sensor 240. Examples of sensor 240 may include, without limitation, accelerometers, gyroscopes, magnetometers, other suitable types of sensors that detect motion, sensors used for error correction of the IMU, or some combination thereof.

Augmented-reality system 200 may also include a microphone array with a plurality of acoustic transducers 220(A)-220(J), referred to collectively as acoustic transducers 220. Acoustic transducers 220 may be transducers that detect air pressure variations induced by sound waves. Each acoustic transducer 220 may be configured to detect sound and convert the detected sound into an electronic format (e.g., an analog or digital format). The microphone array in FIG. 2 may include, for example, ten acoustic transducers: 220(A) and 220(B), which may be designed to be placed inside a corresponding ear of the user, acoustic transducers 220(C), 220(D), 220(E), 220(F), 220(G), and 220(H), which may be positioned at various locations on frame 210, and/or acoustic transducers 220(l) and 220(J), which may be positioned on a corresponding neckband 205.

In some embodiments, one or more of acoustic transducers 220(A)-(F) may be used as output transducers (e.g., speakers). For example, acoustic transducers 220(A) and/or 220(B) may be earbuds or any other suitable type of headphone or speaker.

The configuration of acoustic transducers 220 of the microphone array may vary. While augmented-reality system 200 is shown in FIG. 2 as having ten acoustic transducers 220, the number of acoustic transducers 220 may be greater or less than ten. In some embodiments, using higher numbers of acoustic transducers 220 may increase the amount of audio information collected and/or the sensitivity and accuracy of the audio information. In contrast, using a lower number of acoustic transducers 220 may decrease the computing power required by an associated controller 250 to process the collected audio information. In addition, the position of each acoustic transducer 220 of the microphone array may vary. For example, the position of an acoustic transducer 220 may include a defined position on the user, a defined coordinate on frame 210, an orientation associated with each acoustic transducer 220, or some combination thereof.

Acoustic transducers 220(A) and 220(B) may be positioned on different parts of the user's ear, such as behind the pinna, behind the tragus, and/or within the auricle or fossa. Or, there may be additional acoustic transducers 220 on or surrounding the ear in addition to acoustic transducers 220 inside the ear canal. Having an acoustic transducer 220 positioned next to an ear canal of a user may enable the microphone array to collect information on how sounds arrive at the ear canal. By positioning at least two of acoustic transducers 220 on either side of a user's head (e.g., as binaural microphones), augmented-reality device 200 may simulate binaural hearing and capture a 3D stereo sound field around about a user's head. In some embodiments, acoustic transducers 220(A) and 220(B) may be connected to augmented-reality system 200 via a wired connection 230, and in other embodiments acoustic transducers 220(A) and 220(B) may be connected to augmented-reality system 200 via a wireless connection (e.g., a Bluetooth connection). In still other embodiments, acoustic transducers 220(A) and 220(B) may not be used at all in conjunction with augmented-reality system 200.

Acoustic transducers 220 on frame 210 may be positioned along the length of the temples, across the bridge, above or below display devices 215(A) and 215(B), or some combination thereof. Acoustic transducers 220 may be oriented such that the microphone array is able to detect sounds in a wide range of directions surrounding the user wearing the augmented-reality system 200. In some embodiments, an optimization process may be performed during manufacturing of augmented-reality system 200 to determine relative positioning of each acoustic transducer 220 in the microphone array.

In some examples, augmented-reality system 200 may include or be connected to an external device (e.g., a paired device), such as neckband 205. Neckband 205 generally represents any type or form of paired device. Thus, the following discussion of neckband 205 may also apply to various other paired devices, such as charging cases, smart watches, smart phones, wrist bands, other wearable devices, hand-held controllers, tablet computers, laptop computers, other external compute devices, etc.

As shown, neckband 205 may be coupled to eyewear device 202 via one or more connectors. The connectors may be wired or wireless and may include electrical and/or non-electrical (e.g., structural) components. In some cases, eyewear device 202 and neckband 205 may operate independently without any wired or wireless connection between them. While FIG. 2 illustrates the components of eyewear device 202 and neckband 205 in example locations on eyewear device 202 and neckband 205, the components may be located elsewhere and/or distributed differently on eyewear device 202 and/or neckband 205. In some embodiments, the components of eyewear device 202 and neckband 205 may be located on one or more additional peripheral devices paired with eyewear device 202, neckband 205, or some combination thereof.

Pairing external devices, such as neckband 205, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 200 may be provided by a paired device or shared between a paired device and an eyewear device, thus reducing the weight, heat profile, and form factor of the eyewear device overall while still retaining desired functionality. For example, neckband 205 may allow components that would otherwise be included on an eyewear device to be included in neckband 205 since users may tolerate a heavier weight load on their shoulders than they would tolerate on their heads. Neckband 205 may also have a larger surface area over which to diffuse and disperse heat to the ambient environment. Thus, neckband 205 may allow for greater battery and computation capacity than might otherwise have been possible on a stand-alone eyewear device. Since weight carried in neckband 205 may be less invasive to a user than weight carried in eyewear device 202, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 205 may be communicatively coupled with eyewear device 202 and/or to other devices. These other devices may provide certain functions (e.g., tracking, localizing, depth mapping, processing, storage, etc.) to augmented-reality system 200. In the embodiment of FIG. 2, neckband 205 may include two acoustic transducers (e.g., 220(l) and 220(J)) that are part of the microphone array (or potentially form their own microphone subarray). Neckband 205 may also include a controller 225 and a power source 235.

Acoustic transducers 220(l) and 220(J) of neckband 205 may be configured to detect sound and convert the detected sound into an electronic format (analog or digital). In the embodiment of FIG. 2, acoustic transducers 220(l) and 220(J) may be positioned on neckband 205, thereby increasing the distance between the neckband acoustic transducers 220(l) and 220(J) and other acoustic transducers 220 positioned on eyewear device 202. In some cases, increasing the distance between acoustic transducers 220 of the microphone array may improve the accuracy of beamforming performed via the microphone array. For example, if a sound is detected by acoustic transducers 220(C) and 220(D) and the distance between acoustic transducers 220(C) and 220(D) is greater than, e.g., the distance between acoustic transducers 220(D) and 220(E), the determined source location of the detected sound may be more accurate than if the sound had been detected by acoustic transducers 220(D) and 220(E).

Controller 225 of neckband 205 may process information generated by the sensors on neckband 205 and/or augmented-reality system 200. For example, controller 225 may process information from the microphone array that describes sounds detected by the microphone array. For each detected sound, controller 225 may perform a direction-of-arrival (DOA) estimation to estimate a direction from which the detected sound arrived at the microphone array. As the microphone array detects sounds, controller 225 may populate an audio data set with the information. In embodiments in which augmented-reality system 200 includes an inertial measurement unit, controller 225 may compute all inertial and spatial calculations from the IMU located on eyewear device 202. A connector may convey information between augmented-reality system 200 and neckband 205 and between augmented-reality system 200 and controller 225. The information may be in the form of optical data, electrical data, wireless data, or any other transmittable data form. Moving the processing of information generated by augmented-reality system 200 to neckband 205 may reduce weight and heat in eyewear device 202, making it more comfortable to the user.

Power source 235 in neckband 205 may provide power to eyewear device 202 and/or to neckband 205. Power source 235 may include, without limitation, lithium ion batteries, lithium-polymer batteries, primary lithium batteries, alkaline batteries, or any other form of power storage. In some cases, power source 235 may be a wired power source. Including power source 235 on neckband 205 instead of on eyewear device 202 may help better distribute the weight and heat generated by power source 235.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 300 in FIG. 3, that mostly or completely covers a user's field of view. Virtual-reality system 300 may include a display element 302 and a band 304 shaped to fit around a user's head. Virtual-reality system 300 may also include output audio transducers 306(A) and 306(B). Furthermore, while not shown in FIG. 3, display element 302 may include one or more electronic elements, including one or more electronic displays, one or more inertial measurement units (IMUs), one or more tracking emitters or detectors, and/or any other suitable device or system for creating an artificial reality experience.

Artificial-reality systems may include a variety of types of visual feedback mechanisms. For example, display devices in augmented-reality system 200 and/or virtual-reality system 300 may include one or more liquid crystal displays (LCDs), light emitting diode (LED) displays, organic LED (OLED) displays, digital light project (DLP) micro-displays, liquid crystal on silicon (LCoS) micro-displays, and/or any other suitable type of display screen. Artificial-reality systems may include a single display screen for both eyes or may provide a display screen for each eye, which may allow for additional flexibility for varifocal adjustments or for correcting a user's refractive error. Some artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some artificial-reality systems may include one or more projection systems. For example, display devices in augmented-reality system 200 and/or virtual-reality system 300 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

Artificial-reality systems may also include various types of computer vision components and subsystems. For example, augmented-reality system 200 and/or virtual-reality system 300 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

Artificial-reality systems may also include one or more input and/or output audio transducers. In the examples shown in FIG. 3, output audio transducers 306(A) and 306(B) may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

While not shown in FIG. 2, artificial-reality systems may include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on” or “over” another element, it may be located directly on at least a portion of the other element, or one or more intervening elements may also be present. In contrast, when an element is referred to as being “directly on” or “directly over” another element, it may be located on at least a portion of the other element, with no intervening elements present.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting of” or “consisting essentially of,” are implied. Thus, for example, implied alternative embodiments to a fluid that comprises or includes air include embodiments where a fluid consists essentially of air and embodiments where a fluid consists of air.

What is claimed is:

1. A headset, comprising:
a head-mounted display;
a band connected to the head-mounted display;
an inflatable pad positioned on at least one of the head-mounted display or the band, the inflatable pad comprising at least one chamber; and
a pump mechanism configured to inflate the at least one chamber.

2. The headset of claim 1, wherein the inflatable pad comprises vinyl.

3. The headset of claim 1, wherein the inflatable pad comprises two or more chambers.

4. The headset of claim 1, wherein the inflatable pad comprises two or more independently inflatable chambers.

5. The headset of claim 1, wherein the pump mechanism comprises a manual pump.

6. The headset of claim 1, wherein the pump mechanism comprises an electric pump.

7. The headset of claim 1, further comprising a pressure sensor configured to measure a fluid pressure within the at least one chamber.

8. The headset of claim 1, further comprising a tensioning device configured to adjust a tension of the band.

9. The headset of claim 8, wherein the tensioning device is configured such that operation of the tensioning device is independent of operation of the pump mechanism.

10. The headset of claim 8, wherein the inflatable pad is configured to be inflated or deflated independently from operation of the tensioning device.

11. The headset of claim 8, wherein the tensioning device is configured such that operation of the tensioning device operates the pump mechanism.

12. The headset of claim 8, wherein the tensioning device is configured to make coarse fitting adjustments, and the pump mechanism is configured to make fine fitting adjustments.

13. The headset of claim 8, wherein the tensioning device is configured to adjust an amount of fluid in the inflatable pad based on at least one of an atmospheric condition, a use of the headset, and a level of activity of a wearer.

14. A headset, comprising:
a component;
a band connected to the component, the band configured to be worn around the head of a wearer;
an inflatable pad positioned on at least one of the component or the band, the inflatable pad comprising at least one chamber; and
a pump mechanism configured to inflate the at least one chamber.

15. The headset of claim 14, wherein the component comprises one of a flashlight, camera, and helmet.

16. The headset of claim 14, further comprising a tensioning device configured to adjust a tension of the band.

17. The headset of claim 16, wherein the tensioning device is configured such that operation of the tensioning device is configured to adjust an amount of fluid in the inflatable pad.

18. The headset of claim 16, wherein the tensioning device is configured such that operation of the tensioning device operates the pump mechanism.

19. A headset, comprising:
a head-mounted display;
a band connected to the head-mounted display, the band configured to be worn around the head of a wearer; and
an inflatable pad positioned on at least one of the head-mounted display or the band, the inflatable pad comprising at least one chamber, wherein the at least one chamber is configured to be inflated by a fluid.

20. The headset of claim 19, further comprising a pressurized fluid source configured to inflate the at one chamber with the fluid.
